(19) United States
(12) Patent Application Publication
(10) Pub. No.: US 2008/0253589 A1
(43) Pub. Date: Oct. 16, 2008

(54) Ultrasound Imaging System with Voice Activated Controls Using Remotely Positioned Microphone

(75) Inventor: Robert Trahms, Bothell, WA (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., Eindhoven (NL)

(21) Appl. No.: 12/067,200

(22) PCT Filed: Sep. 15, 2006
(86) PCT No.: PCT/IB06/53320

§ 371 Date: Mar. 18, 2008

Related U.S. Application Data
(60) Provisional application No. 60/719,413, filed on Sep. 21, 2005.

(51) Int. Cl. H04R 3/00

(52) U.S. Cl. 381/110

(57) ABSTRACT

An ultrasound imaging system includes a direction-tracking microphone that is able to determine the direction of a voice command and to cause the microphone to selectively receive acoustic inputs from the determined direction. A voice recognition then interprets the voice command and controls the operation of the ultrasound imaging system accordingly. The direction tracking microphone may, for example, select one of several unidirectional microphones that receives the loudest signal or a phased array of omnidirectional microphones.

This invention relates to operator controls for ultrasound imaging systems, and, more particularly to voice control of an ultrasound imaging system using a microphone that is positioned remotely from an operator of the system.

In recent years the development of voice recognition technology has advanced the day when hands-free control of an ultrasound system will be effective as users control their ultrasound systems audibly. A number of ultrasound system manufacturers including the assignee of the present application have developed and demonstrated prototype voice-controlled ultrasound systems. One such system is described in U.S. Pat. No. 5,544,654, which is incorporated herein by reference. In the system described in U.S. Pat. No. 5,544,654, a microphone is connected to a personal computer, which interprets voice commands and issues corresponding command signals to an ultrasound system. The microphone shown in the application is a headset microphone, although the patent contemplates the use of other microphones worn by the sonographer or other operator and even a “far-talk” microphone mounted on the personal computer or ultrasound machine.

Other voice controlled ultrasound imaging systems are described in U.S. Pat. No. 6,743,175 and U.S. Patent Published Application Nos. 2003/0068011 and 2005/0054922, all of which are incorporated herein by reference.

There are two primary limitations to the approaches described in U.S. Pat. No. 5,544,654. The primary approach of using a microphone worn by the sonographer tethers the sonographer to the ultrasound imaging system with a cable connecting the microphone to the imaging system. The length of the cable restricts the distance the sonographer can move away from the imaging system. The length of the cable, can, of course, be increased, but doing so only exacerbates the problem of the cable getting caught on or wrapped around objects or getting tangled.

The other approach contemplated by U.S. Pat. No. 5,544,654—the use of a “far-talk” microphone—has the advantage of freeing the sonographer from being physically connected to the ultrasound imaging system. However, it is completely impractical with today's voice recognition technology. As is well understood in the art, the accuracy of any voice recognition system is heavily dependent on the quality of the audio signal input to the voice recognition system. Even a moderately poor signal-to-noise ratio generally makes voice recognition unusable. The use of a “far-talk” microphone might provide an audio signal having an adequate signal-to-noise ratio in a very quite controlled environment, such as an anechoic chamber. But it would certainly not provide an audio signal of adequate quality in a hospital lab or surgical suite or other medical environment where many noise sources are present. Attempts could be made to develop filtering software to screen out noise sources. Some of the noise sources than can be expected in a hospital environment are equipment noise, air conditioning and heating noises, background conversation and street noise, to name a few. The potential noise sources are therefore too plentiful in number and varied in nature to make filtering practical. Also, some noise sources are voices such as pages over sound systems, that cannot be filtered without making the voice recognition system unusable.

There is therefore a need for a voice controlled ultrasound imaging system that does not require a sonographer to wear a microphone and yet can provide an audio input signal of adequate quality to ensure accuracy with presently existing voice recognition capabilities.

A system and method for providing an ultrasound image includes a direction-tracking microphone that determines the direction of a voice command. The direction-tracking microphone then provides an audio signal corresponding to sound selectively received from the determined direction. The audio signal is provided to a voice recognition system that interprets the audio signal to detect voice commands. The voice recognition system then generates command signals corresponding to the detected voice command and provides the command signal to an ultrasound imaging system. The operation of the ultrasound imaging system is controlled in accordance with the command signals. The ultrasound imaging system preferably includes a display having a display screen. In such case, the direction-tracking microphone is preferably mounted on the display and is selectively sensitive in the same direction that the display screen faces. The voice recognition system may be hardware or software based, and it may be either a stand-alone unit or an integral part of the ultrasound imaging system.

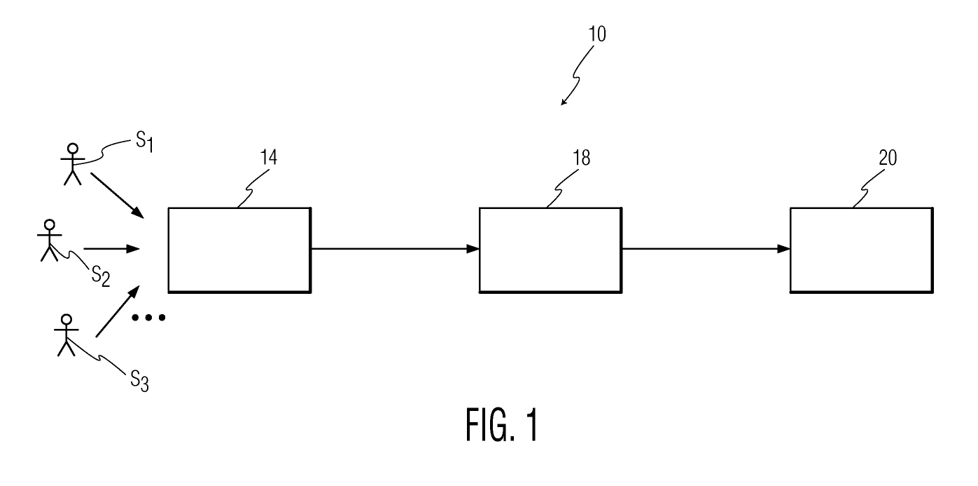

FIG. 1 is a system block diagram of a voice-controlled ultrasound imaging system according to one example of the invention.

FIG. 2 is a schematic drawing illustrating why conventional voice controlled imaging systems using a far field microphone are not capable of providing audio signals of adequate quality to ensure voice recognition accuracy.

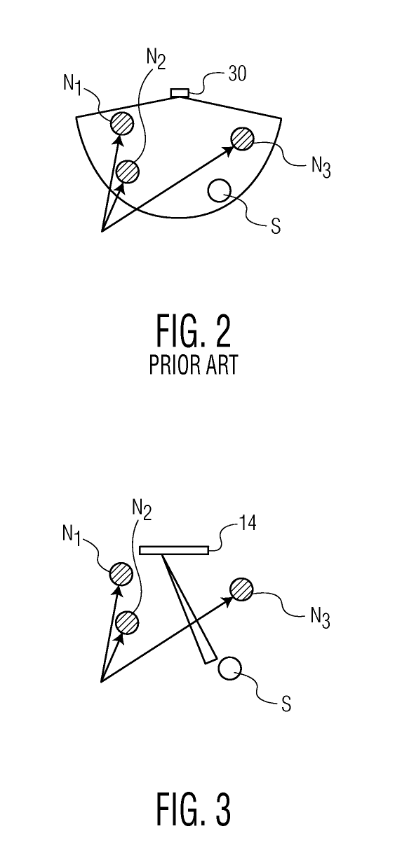

FIG. 3 is a schematic drawing illustrating why a voice controlled imaging system using a direction-tracking microphone according to one example of the invention is capable of providing audio signals of adequate quality to ensure voice recognition accuracy.

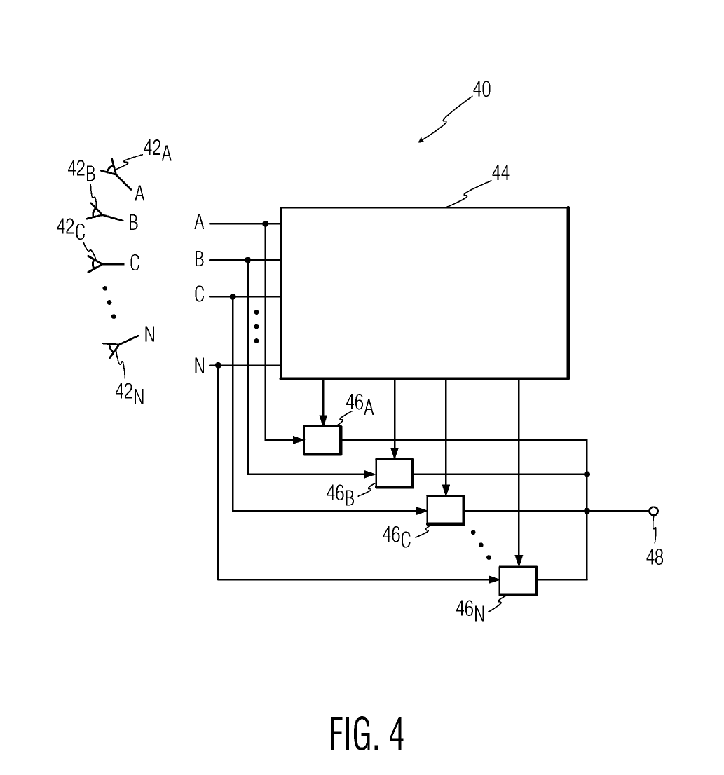

FIG. 4 is a block diagram of a direction-tracking microphone according to one example of the invention that can be used in the voice-controlled ultrasound imaging system of FIG. 1.

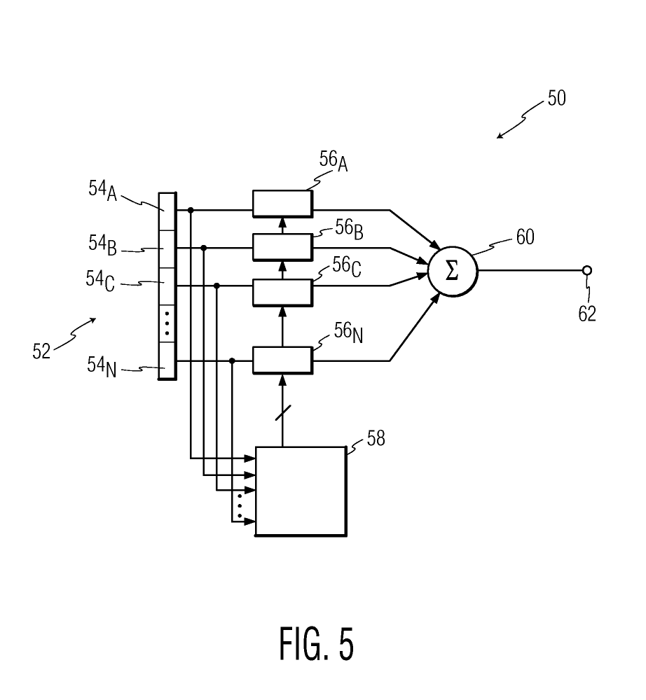

FIG. 5 is a block diagram of a direction-tracking microphone according to another example of the invention that can be used in the voice-controlled ultrasound imaging system of FIG. 1.

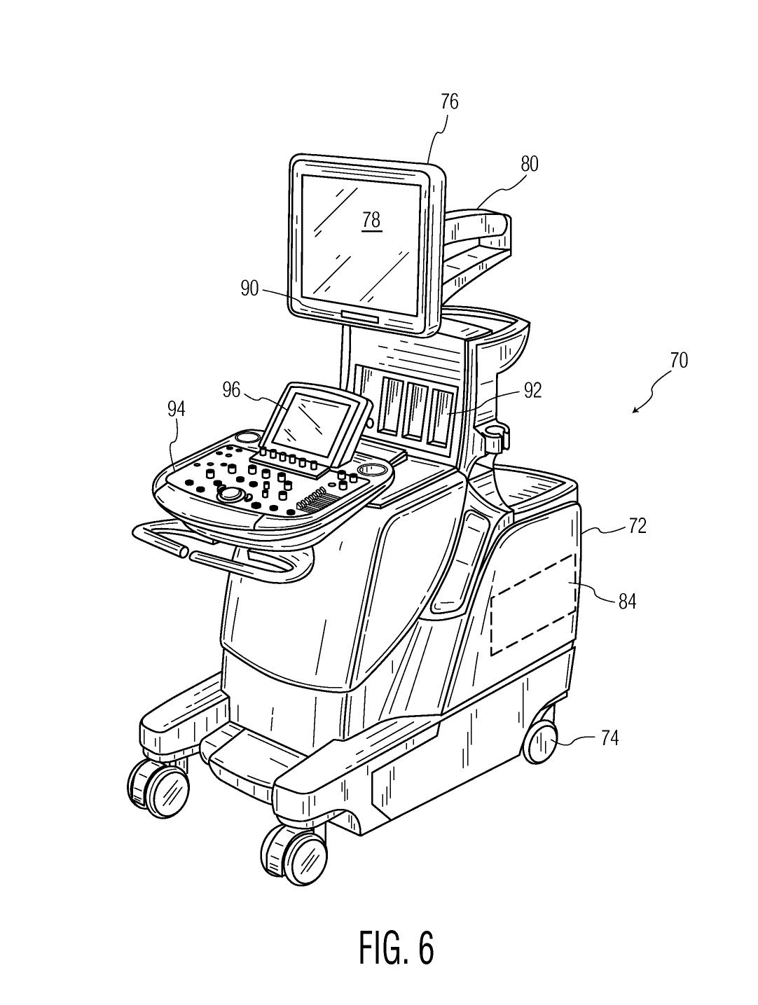

FIG. 6 is an isometric view of an ultrasound imaging system according to one example of the invention.

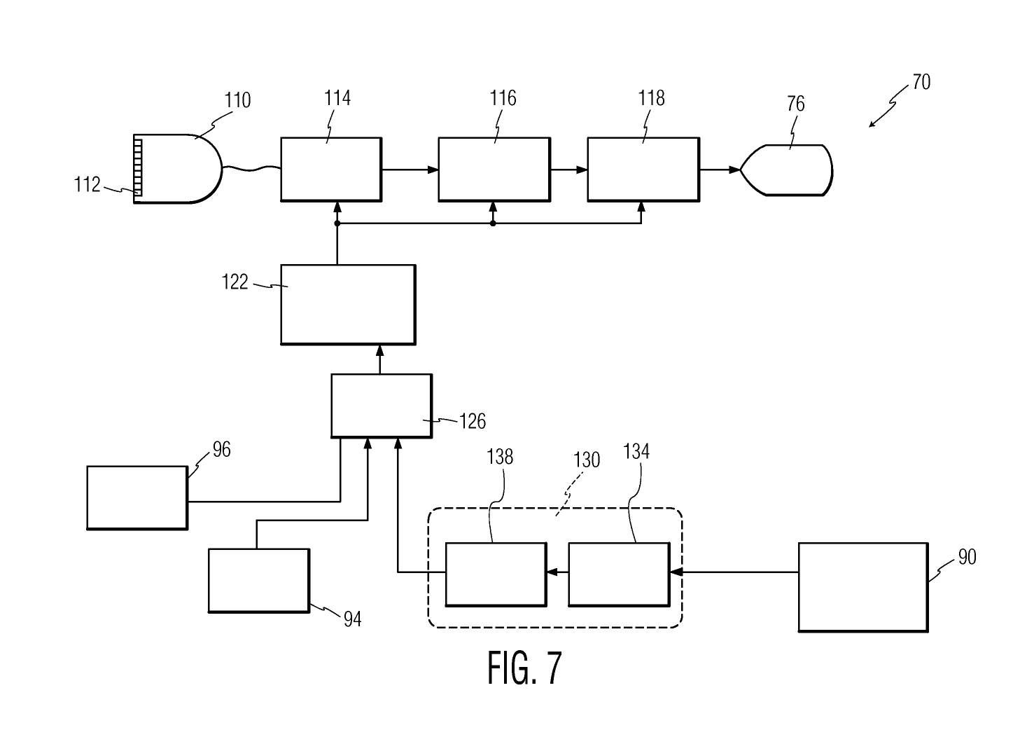

FIG. 7 is a block diagram of the electrical components used in the ultrasound imaging system of FIG. 6 according to one example of the invention.

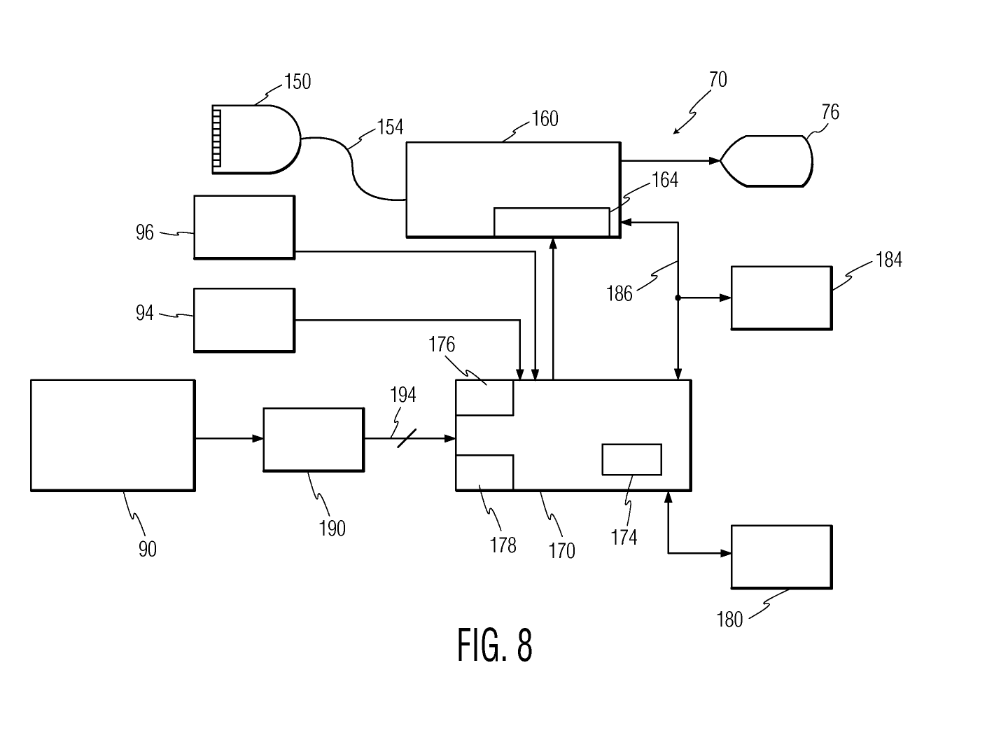

FIG. 8 is a block diagram of the electrical components used in the ultrasound imaging system of FIG. 6 according to another example of the invention.

The basic components of a voice-controlled ultrasound imaging system 10 according to one example of the invention is shown in FIG. 1. A direction-tracking microphone 14 is used to provide audio signals from one or more sonographers S₁, S₂, S₃. The audio signals from the microphone 14 are applied to a voice recognition system 18. The voice recognition system 18 interprets voice commands based on the audio signal and issues corresponding command signals to an ultrasound imaging system 20. The ultrasound imaging system 20 then performs operations called for by the voice commands.

The sonographers S₁, S₂, S₃ are assumed to be in the audible vicinity of the ultrasound imaging system 20, although they may not necessarily be positioned in the same direction from the system 20. The directional microphone 14 uses one of several technologies discussed below to quickly track voice commands from any of the sonographers S₁, S₂, S₃. Once the microphone 14 has determined the direction of an audio source, it selectively responds to acoustic inputs only from that direction. The microphone 14 is also able to track any movement of the audio source by changing the direction from which it selectively responds to acoustic inputs. The microphone is able to perform these functions very quickly, preferably within a few milliseconds, so that the voice recognition system 18 can interpret the entire voice-command, including the initial portion of the command.

The voice-recognition system 18 may be a stand-alone electronic unit, a personal computer running a conventional or specially developed voice recognition application, electronic circuitry built into the ultrasound imaging system 20, a processor in the imaging system 20 running a conventional or specially developed voice recognition application, or some other type of voice recognition system. Systems having such voice recognition capability are conventional, and are commercially available from a variety of sources and are described in some of the previously cited patents and patent applications.

The manner in which the direction-tracking microphone 14 is able to provide an audio signal of adequate quality to ensure accuracy with presently existing voice recognition capabilities is illustrated in FIG. 3 in comparison to conventional approaches illustrated in FIG. 2. With reference, first, to FIG. 2, a conventional “far-talk” microphone 30 of the type described in U.S. Pat. No. 5,544,654 is connected to an ultrasound imaging system (not shown) having voice command recognition capability. A sonographer S and three noise sources, N₁, N₂, N₃, are located in audible range of the microphone 30. The microphone 30 may have omnidirectional characteristics or it may be somewhat directional. In either case, the microphone 30 is capable of picking up voice commands from the sonographer S, but it also picks up sound from the noise sources, N₁, N₂, N₃ As a result, the signal-to-noise ratio of the audio signal that the microphone 30 applies to the voice recognition system is of insufficient quality to ensure accurate recognition of the voice commands.

In contrast to the use of a far-talk microphone 30 as shown in FIG. 2, the direction tracking microphone 14 is able to provide an audio signal of sufficient quality to ensure accurate recognition of the voice commands for the reasons illustrated in FIG. 3. As shown in FIG. 3, the direction tracking microphone 14 used in the system 10 (FIG. 1) has a very directional sensitivity. As a result, once it determines the direction of voice commands from the sonographer S, the microphone 14 receives sound from only the sonographer S. Significantly, the microphone 14 is substantially insensitive to sound from the noise sources N₁, N₂, N₃. As a result, the audio signal from the microphone 14 has substantially the same quality as an audio signal from a microphone worn by the sonographer S.

One example of a direction tracking microphone 40 that can be used as the direction tracking microphone 14 in the system 10 is shown in FIG. 4. An array of unidirectional microphones 42_{A}, 42_{B}, 42_{C} . . . 42_{N} are arranged so that they are sensitive to acoustic inputs from a range of respective directions. Each of the microphones 42_{A}, 42_{B}, 42_{C} . . . 42_{N} produces a respective audio signal A, B, C . . . N. All of the audio signals A, B, C . . . N are applied to a comparator 44, and each of the audio signals A, B, C . . . N are applied to a respective switch 46_{A}, 46_{B}, 46_{C} . . . 46_{N}. The outputs of the switches 46_{A}, 46_{B}, 46_{C} . . . 46_{N} are connected to each other and to an output terminal 48 of the direction tracking microphone 40. The operation of the switches 46_{A}, 46_{B}, 46_{C} . . . 46_{N} is controlled by respective outputs from the comparator 44.

In operation, the comparator 44 compares the amplitudes of all of the signals A, B, C . . . N from the unidirectional microphones 42_{A}, 42_{B}, 42_{C} . . . 42_{N} and determines which of these signals A, B, C . . . N has the greatest amplitude. The comparator 44 then outputs a control signal to the corresponding switch 46_{A}, 46_{B}, 46_{C} . . . 46_{N}, which connects the audio signal with the greatest amplitude to the output terminal 48.

The operation of the direction-tracking microphone 40 proceeds on the assumption that a voice command from a sonographer will be louder than any noise sources in the vicinity of the unidirectional microphones 42_{A}, 42_{B}, 42_{C} . . . 42_{N}. This assumption is normally valid. However, when an ultrasound imaging system is to be used in a very noisy environment, the comparator 44 can employ processing techniques, such as filtering, to make the comparison more sensitive to voice commands and less sensitive to the noise sources.

Another example of a direction tracking microphone 50 that can be used as the direction tracking microphone 14 in the system 10 is shown in FIG. 5. A linear array 52 of either omnidirectional or slightly directional microphones 54_{A}, 54_{B}, 54_{C} . . . 54_{N} is used. All of the microphones 54_{A}, 54_{B}, 54_{C} . . . 54_{N} receive voice commands as well as any noise in the proximity of the microphones. An audio signal output by each of the microphones 54_{A}, 54_{B}, 54_{C} . . . 54_{N} is applied to a respective delay unit 56_{A}, 56_{B}, 56_{C} . . . 56_{N}, which delays the audio signal from the respective microphone 54_{A}, 54_{B}, 54_{C} . . . 54_{N} by a respective delay value received from a delay control unit 58. The delay control unit 58 receives all of the audio signals from the microphones 54_{A}, 54_{B}, 54_{C} . . . 54_{N}. The respective outputs of the delay unit 56_{A}, 56_{B}, 56_{C} . . . 56_{N} are applied to a summation circuit 60, which generates a composite audio signal at an output terminal 62.

In operation, the delay control unit 58 uses the signals from the microphones 54_{A}, 54_{B}, 54_{C} . . . 54_{N} to determine the direction of a voice command. The delay control unit 58 then sets the delay of each of the delay units 56_{A}, 56_{B}, 56_{C} . . . 56_{N} using conventional phased-array techniques to selectively receive sound from the determined direction. The source of the voice commands may, of course, move, and a voice command may be subsequently be received from a different direction. In such case, the delay control unit 58 quickly determines the direction of movement of the source of the voice command or the direction of the new voice command, and generates the proper delay control signals to steer the acoustic directional response of the array 52 to the direction of the voice command.

In other examples of the direction tracking microphone 50, the delay control unit 58 not only determines the direction of the voice command, but it also determines the distance of the voice command from the array 52 using conventional processing techniques. The delay control unit 58 then sets the delay of each of the delay units 56_{A}, 56_{B}, 56_{C} . . . 56_{N} using conventional phased-array techniques to selectively receive sound from the determined distance as well as direction.

An ultrasound imaging system 70 according to one example of the invention is shown in FIG. 6. The system 70 includes a chassis 72 containing most of the electronic circuitry for the system 70. The chassis 72 is mounted on a cart 74, and a display 76 having a display screen 78 is mounted on the chassis 72. The display 76 is supported on the chassis 72 by an articulating arm 80 that allows the display 76 to be in virtually any position and the screen 78 to face in virtually any direction. As a result, a sonographer or other medical personnel need not be positioned in front of the chassis 72 during an exam. However, the ability of the sonographer and possibly other medical personnel to be at virtually any location presents challenges to a voice command recognition system 84 that is included in the chassis 72. The system 70 meets this challenge by placing a direction-tacking microphone 90 on the display 76 facing the same direction that the display screen 78 faces. The direction-tacking microphone 90 is mounted at this location on the assumption that the sonographer and any other medical personnel involved in an examination will always be located in view of the screen 78. Therefore, the direction-tacking microphone 90 will always face generally toward the sonographer and any other medical personnel viewing and using the system. The microphone 90 then selectively receives voice commands from a single direction at a time from the area in front of the screen 78, as explained above. The direction-tacking microphone 90 may be either the direction-tacking microphone 40 shown in FIG. 4, the direction-tacking microphone 50 shown in FIG. 5, or a direction-tacking microphone according to some other example of the invention.

With further reference to FIG. 6, an ultrasound imaging probe (not shown) normally plugs into one of three connectors 92 on the chassis 72. Although the system 70 can be controlled by the voice commands, the chassis 72 also includes control panel 94 containing a keyboard and controls for allowing a sonographer to manually operate the ultrasound imaging system 70 and enter information about the patient or the type of examination that is being conducted. At the back of the control panel 94 is a touchscreen display 96 on which programmable softkeys are displayed for supplementing the voice command recognition system 84 in controlling the operation of the system 10.

One example of electrical components used in the ultrasound imaging system 70 of FIG. 6 are illustrated in FIG. 7. An ultrasound probe 110 including an array transducer 112 is operated under control of a beamformer 114 which causes the array transducer to transmit ultrasound beams into the body of a patient and receive echo signals in return. The received echo signals are formed into a receive beam of coherent echo signals by the beamformer 114 which is coupled to a signal processor 116. The signal processor performs function such as filtering, demodulation, detection or Doppler estimation using the coherent echo signals. The processed echo signals are coupled to an image processor 118 where they are processed to form image information such as B or M mode image signals or color or spectral Doppler image signals in a two or three dimensional image format. The image information is then coupled to the display 76 (FIG. 6) where an image is shown on the screen 78. The functioning of the beamformer 114 and processors 116, 118 of the ultrasound system is directed by a system controller 122, which controls and coordinates the functioning of these elements, including initializing and changing their states of operation so that the display device will display the type of information desired by the ultrasound system operator.

In a conventional ultrasound imaging system, the system controller 112 receives operator issued control commands from only the control panel 94 (FIG. 6) and the touchscreen display 96. In accordance with one example of the invention, the control panel 94 and the touchscreen display 96 are coupled to the system controller 122 by a command multiplexer (mux) 126. The command mux 126 enables the system controller 122 to receive input signals from any of the control panel 94, the touchscreen display 96, or a voice controller 130. The command mux 126 may also multiplex input signals from other control devices, such as a footswitch (not shown). The voice controller 130 includes a voice recognition processor 134 which responds to voice input from the direction tracking microphone 90 by producing digital output signals representing the audible information. The direction tracking microphone 90 may be the direction tracking microphone 40 shown in FIG. 4, the direction tracking microphone 50 shown in FIG. 5, or a direction tracking microphone according to some other example of the invention.

A command encoder 138 converts the digital output signals of the voice recognition processor 134 into digital command signals useable by the system controller 122. The voice recognition processor 134 and the command encoder 138 may be integrated into a single unit which receives audio input signals and produces ultrasound system control signals as output signals. The command mux 126 is selectively conditioned to respond to signals from the control panel 94, the touchscreen display 96, the voice controller 130, or both and to couple the signals to the system controller 122. The system controller 122 responds to these inputs by effecting a change to the current state of the ultrasound system, such as changing a mode or displaying new or different information on the display.

The electrical components of the ultrasound imaging system 70 according to another example of the invention are illustrated in FIG. 8. The ultrasound imaging system 70 includes an ultrasound imaging probe 150, which is connected by a cable 154 to an ultrasound signal path 160 of conventional design. As is well-known in the art, the ultrasound signal path 160 includes a transmitter (not shown) coupling electrical signals to the probe 150, an acquisition unit (not shown) that receives electrical signals from the probe 150 corresponding to ultrasound echoes, a signal processing unit (not shown) that processes the signals from the acquisition unit to perform a variety of functions such as isolating returns from specific depths or isolating returns from blood flowing through vessels, and a scan converter (not shown) that converts the signals from the signal processing unit so that they are suitable for use by the display 76. The ultrasound signal path 160 in this example is capable of processing both B mode (structural) and Doppler signals for the production of various B mode and Doppler volumetric images, including spectral Doppler volumetric images. The ultrasound signal path 160 also includes a control module 164 that interfaces with a processing unit 170, which controls the operation of the above-described units. The ultrasound signal path 160 may, of course, contain components in addition to those described above, and, in suitable instances, some of the components described above may be omitted.

The processing unit 170 contains a number of components, including a central processor unit (“CPU”) 174, random access memory (“RAM”) 176, and read only memory (“ROM”) 178, to name a few. As is well-known in the art, the ROM 178 stores a program of instructions that are executed by the CPU 174, as well as initialization data for use by the CPU 174. The RAM 176 provides temporary storage of data and instructions for use by the CPU 174. The processing unit 170 interfaces with a mass storage device such as a disk drive 180 for permanent storage of data, such as data corresponding to ultrasound images obtained by the system 70. However, such image data is initially stored in an image storage device 184 that is coupled to a signal path 186 extending between the ultrasound signal path 160 and the processing unit 170. The disk drive 180 also preferably stores protocols which may be called up and initiated to guide the sonographer through various ultrasound exams.

The processing unit 170 also interfaces with the control panel 94 and the touchscreen display 96. According to one example of the invention, the system 70 also includes an analog-to-digital (“A/D”) converter 190 that receives analog audio signals from the direction tracking microphone 90. The A/D converter 190 digitizes the audio signal to provide periodic samples that are transmitted in digital form through a bus 194 to the processing unit 170. The processing unit receives instructions from either the ROM 178 or the disk storage 180 for a conventional or hereinafter developed voice recognition application that is executed by the CPU 174. The voice recognition application interprets voice commands and causes the processing unit 170 to apply corresponding command signals to the control module 164 in the ultrasound signal path 160.

What is claimed is:

1. A system for providing an ultrasound image, comprising:
a direction-tracking microphone operable to determine the direction of a voice command and to provide an audio signal corresponding to sound selectively received from the determined direction;
a voice recognition system coupled to the direction-tracking microphone, the voice recognition system receiving the audio signal from the direction-tracking microphone, interpreting the audio signal to detect voice commands, and to provide command signals corresponding to the detected voice command; and
an ultrasound imaging system coupled to the voice-recognition system, the ultrasound imaging system receiving the command signals from the voice recognition system and controlling the ultrasound imaging system in accordance with the command signals.

2. The system of claim 1 wherein the voice recognition system comprises:
a processor; and
a voice recognition program executed by the processor.

3. The system of claim 2 wherein the processor is an integral component of the ultrasound imaging system and is operable to control the operation of the ultrasound imaging system.

4. The system of claim 1 wherein the ultrasound imaging system includes a display having a display screen, and wherein the direction-tracking microphone is mounted on the display and is selectively sensitive in the same direction that the display screen faces.

5. The system of claim 1 wherein the direction-tracking microphone is further operable to determine the distance of a voice command from the direction-tracking microphone and to selectively receive sound from the determined distance.

6. The system of claim 1 wherein the direction-tracking microphone comprises a phased-array direction-tracking microphone.

7. The system of claim 6 wherein the direction-tracking microphone comprises:
a plurality of microphones each of which has an acoustic sensitivity pattern that encompasses a plurality of the directions from which a voice command can be expected, each of the microphones being operable to provide a respective audio signal corresponding to sound received by the microphone;
a plurality of delay units each of which has an input coupled to a respective one of the microphones to receive the audio signal from the microphone, each of the delay units being operable to produce a delayed audio signal by delaying the audio signal by a delay corresponding to a delay value applied to a control terminal of the delay unit;
a delay control unit coupled to the microphones to receive the audio signals from the microphones, the delay control unit being operable to determine the direction of a voice command based on the received audio signals and to apply the delay values to the control terminals of the delay units so that, collectively, the microphones are selectively sensitive in the determined direction; and
a summer connected to receive the delayed audio signals from the delay units and combining the delayed audio signals into a composite audio signal.

8. The system of claim 1 wherein the direction-tracking microphone is operable to perform its direction tracking function based on the amplitude of sounds received by the direction-tracking microphone.

9. The system of claim 8 wherein the direction-tracking microphone comprises:
a plurality of unidirectional microphones having acoustic sensitivity patterns extending in different directions, each of the unidirectional microphones being operable to provide a respective audio signal corresponding to sound received by the unidirectional microphone;
a plurality of switches each having an input, an output and a control terminal, each of the switches having its input coupled to an audio signal from a respective one of the unidirectional microphones and having its output coupled to a common output terminal, each of the switches being operable to connect its input to its output responsive to receipt of a control signal at its control terminal; and
a comparator receiving the audio signals from the unidirectional amplifiers, the comparator being operable to compare the amplitude of the audio signals received from the plurality of unidirectional microphones and to identify the unidirectional microphone from which the audio signal having the highest amplitude is provided, the comparator further being operable to apply the control signal to the control terminal of the switch that has its input coupled to the identified unidirectional microphone.

10. The system of claim 1 wherein the direction-tracking microphone is operable to determine the direction of a voice command and to provide an audio signal corresponding to sound selectively received from the determined direction within a few milliseconds of the start of the voice command.

11. The system of claim 1 wherein the direction-tracking microphone further comprises a processor that causes the direction-tracking function of the microphone to be selectively responsive to voice sounds.

12. The system of claim 1 wherein the voice recognition system comprises an integral part of the ultrasound imaging system.

13. A method of controlling the operation of an ultrasound imaging system, comprising:
determining the direction of a voice command;
selectively receiving sound, including the voice command, from the determined direction;
recognizing an ultrasound imaging system command based on the received voice command;
performing an operation in the ultrasound imaging system corresponding to the recognized ultrasound imaging system command.

14. The method of claim 13 wherein the act of recognizing an ultrasound imaging system command based on the received voice command is performed by the ultrasound imaging system.

15. The method of claim 13 wherein the ultrasound imaging system includes a display having a display screen, and wherein the method further comprises:
ascertaining a direction that the display screen faces; and
selectively receiving sound, including the voice command, from the ascertained direction.

16. The method of claim 13, further comprising:
determine the distance of a voice command; and
selectively receive sound, including the voice command, from the determined distance.

17. The method of claim 13 wherein the acts of determining the direction of a voice command and selectively receiving sound from the determined direction comprise:
receiving sound at a plurality of locations, the sound being received at each of the locations from a relatively wide angle that encompasses a plurality of the directions from which a voice command can be expected;
determining the direction of a voice command based on the sound of the voice command received at each of the locations;
providing delayed sounds by delaying the sound of the voice command received at each of the locations by respective delays that cause the delayed sounds received from the determined direction to be coherent; and
summing the delayed sounds to provide a composite sound that is used to recognize an ultrasound imaging system command.

18. The method of claim 13 wherein the acts of determining the direction of a voice command and selectively receiving sound from the determined direction comprise:
receiving sound at a plurality of locations, the sound being received at the locations from relatively narrow angles extending in different directions;
determining the location at which the received sound is the loudest; and
using the voice command received at the determined location to recognize an ultrasound imaging system command.

19. The method of claim 13 wherein the acts of determining the direction of a voice command and selectively receiving the voice command from the determined direction comprises determining the direction of the voice command and selectively receiving the voice command from the determined direction within a few milliseconds of the start of the voice command.
